(19) United States
(12) Patent Application Publication
(10) Pub. No.: US 2018/0113210 A1
(43) Pub. Date: Apr. 26, 2018

(54) Mountable Radar System

(71) Applicant: Waymo LLC, Mountain View, CA (US)

(72) Inventor: Jamal Izadian, Mountain View, CA (US)

(21) Appl. No.: 15/331,556

(22) Filed: Oct. 21, 2016

(51) Int. Cl. G01S 13/93; G01S 13/90

(52) U.S. Cl. CPC G01S 13/931; G01S 2007/027; G01S 13/90

(57) ABSTRACT

Examples relating to mountable radar systems are described. An example radar system may include a housing structure with a first set and second set of radar units coupled to the housing structure. The first set of radar units may operate in a long range mode and may include four radar units with each respective radar unit mounted at approximately 90 degree increments. The second set of radar units may operate in a short range mode and may include four radar units with each respective radar unit mounted at approximately 90 degrees increments in between two radar units of the first set of radar units. In some implementations, radar units of the first set may include a synthetic aperture radar (SAR) array, a multiple-input multiple-output (MIMO) transmission array, and a receiver array, and radar units of the second set may include a transmit array, and a receiver array.

### BACKGROUND

Vehicles are often used for various tasks, such as for the transportation of people and goods throughout an environment. With advances in technology, some vehicles are configured with systems that enable the vehicles to operate in a partial or fully autonomous mode. When operating in a partial or fully autonomous mode, some or all of the navigation aspects of vehicle operation are controlled by a vehicle control system rather than a traditional human driver. Autonomous operation of a vehicle can involve systems sensing the vehicle's surrounding environment to enable a computing system to plan and safely execute navigating routes to reach desired destinations.

### SUMMARY

Disclosed herein are example implementations of mountable radar systems. An example radar system may include a set of radar units configured to operate in a long range mode and a set of radar units configured to operate in a short range mode. Both sets of radar units may be connected to a housing structure that includes mechanical components that enable the radar system to be coupled to a vehicle. In some example configurations, the long range mode radar units may be coupled to the housing structure in 90 degrees increments with the short range mode radar units positioned in between each set of two long range mode radar units. As such, the configuration of the radar units within the radar system may enable the radar system to capture measurements of a vehicle's surroundings at various distances from the vehicle.

In one aspect, an example radar system is provided. The example radar system may include a housing structure and a first set of radar units coupled to the housing structure. The first set of radar units may include four radar units with each respective radar unit mounted at approximately 90 degree increments. In some instances, the first set of radar units may operate in a long range mode. The example radar system may also include a second set of radar units coupled to the housing structure. The second set of radar unit may include four radar units with each respective radar unit mounted at approximately 90 degrees increments with each radar unit of the second set of radar units positioned between two radar units of the first set of radar units. In some implementations, the second set of radar units may operate in a short range mode.

In another aspect, an example vehicle-mounted radar system is provided. The vehicle-mounted radar system may include a housing structure coupled to a roof of a vehicle and a first set of radar units coupled to the housing structure. In some implementations, the first set of radar units may include four radar units with each respective radar unit mounted at approximately 90 degree increments, and the first set of radar units may operate in a long range mode. The vehicle-mounted radar system may include a second set of radar units coupled to the housing structure. In some implementations, the second set of radar unit may include four radar units with each respective radar unit mounted at approximately 90 degrees increments with each radar unit of the second set of radar units positioned between two radar units of the first set of radar units. The second set of radar units may operate in a short range mode.

In yet another example, an example method of operating a radar system is provided. The method may include transmitting long range radar signals using a first set of radar units coupled to a housing structure. For instance, the first set of radar units may include four radar units with each respective radar unit mounted at approximately 90 degree increments. The method may further include transmitting short range radar signals using a second set of radar units coupled to the housing structure. For instance, the second set of radar units may include four radar units with each respective radar unit mounted at approximately 90 degree increments with each radar unit of the second set of radar units positioned between two radar units of the first set of radar units.

In a further aspect, a system comprising means for transmitting long range radar signals using a first set of radar units coupled to a housing structure. For instance, the first set of radar units may include four radar units with each respective radar unit mounted at approximately 90 degree increments. The system may further include means for transmitting short range radar signals using a second set of radar units coupled to the housing structure. For instance, the second set of radar units may include four radar units with each respective radar unit mounted at approximately 90 degree increments with each radar unit of the second set of radar units positioned between two radar units of the first set of radar units.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a functional block diagram illustrating an example vehicle.

FIG. 2 depicts an example physical configuration of a vehicle.

FIG. 3 illustrates a top view of an example mountable radar system.

FIG. 4A depicts a top view of an example mountable radar system transmitting long range radar signals from a vehicle.

FIG. 4B depicts a top view of an example mountable radar system transmitting short range radar signals from a vehicle.

FIG. 4C depicts a top view of an example mountable radar system transmitting long range and short range radar signals from a vehicle.

FIG. 5 illustrates an example scenario of a vehicle using a mountable radar system.

FIG. 6 is a flow chart of a method, according to an example embodiment.

FIG. 7 depicts a schematic diagram of an example computer program.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A radar system for a vehicle is often used to sense an environment in a forward direction of the vehicle. For example, the radar system may measure the distance between the vehicle and another vehicle navigating in front of the vehicle. Although this type of radar system may improve forward navigation for the vehicle, the radar system does not provide a 360-degree view of the vehicle's surrounding environment.

The following detailed description relates to example methods and systems for implementing mountable radar systems that may be configured to obtain measurements at multiple directions around a vehicle rather than just the area directly in front of the vehicle. An example radar system may include a housing structure configured with radar units arranged to obtain measurements at different directions. The housing structure can have various configurations within examples and may include mechanical components that enable the housing structure to connect to the roof or another portion of a vehicle. As such, the radar system may include multiple sets of radar units, such as a first set of radar units configured to operate in a long range mode and a second set of radar units configured to operate in a short range mode. For example, the radar system may include four long range radar units coupled to the housing structure in a circular configuration to obtain measurements at directions in approximately 90 degree increments. Additionally, the radar system may also include four radar units configured to operate in a short range mode with each short range radar unit mounted to the housing structure between sets of two long range mode radar units. With this configuration, each radar unit operating in the short range mode may be positioned at 90 degrees from the other short range radar units. In other example implementations, a radar system can include other quantities and types of radar units.

In a further aspect, the housing structure of an example radar system may connect to a roof of a vehicle such that one or more radar units have a radar beam or radar beams directed at an angle pointed toward a ground surface (e.g., the road). For example, the housing structure may connect to the roof of a vehicle such that radar units operating in a short range mode have a radar beam directed at an angle pointed towards the road. As a result, the short range radar units may capture measurements of passengers approaching to enter the vehicle or elements of the roadway (e.g., curbs) positioned along the road. The radar units may also capture measurements of other objects or entities within examples. In other implementations, the housing structure of an example radar system may connect to a roof of a vehicle such that one or more radar units are directed at other orientations relative to the vehicle (e.g., an upward orientation).

As indicated above, an example radar system may include different types of radar units, such as long range or short range radar units. For example, a radar system may include one or more radar units configured to operate in a long range mode through the use of one or more of a synthetic aperture radar (SAR) array, a multiple-input multiple-output (MIMO) transmission array, and a receiver array. A long range radar unit may include one or more SAR arrays with beam widths of approximately 45 degrees and/or one or more MIMO transmission arrays with beam widths of approximately 90 degrees. Other types of long range radar units may be used within example radar systems.

Additionally, an example radar system may include one or more radar units that operate in a short range through the use of a transmit array and/or a receiver array. For example, a short range radar unit may include a linear array that serves as the transmit array and a receiver array that is coupled to a digital beam forming unit. Other types of short range radar units may be used within example radar systems.

Example radar systems described herein may capture measurements of a vehicle's surroundings. As such, a computing system of a vehicle may use measurements from an example radar system to determine control operations. For example, the computing system may process measurements from the radar system to determine navigation and obstacle avoidance operations. Some example radar systems described herein may be used to enable a non-autonomous vehicle to operate in a partial or fully autonomous mode. For instance, an example radar system may also be configured to supplement other sensor systems of a vehicle within some implementations.

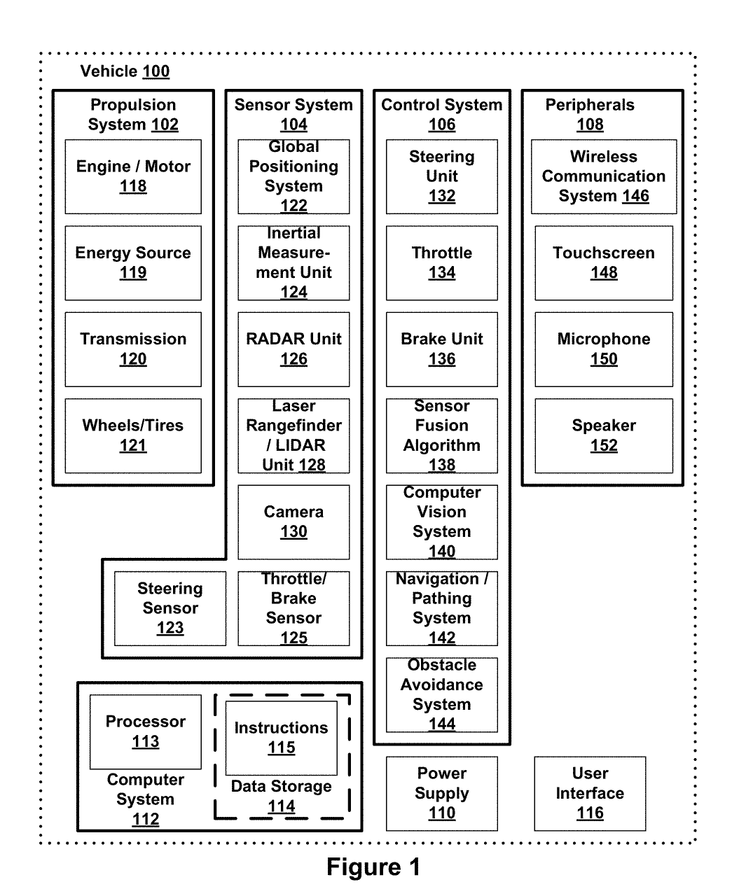

Referring now to the figures, FIG. 1 is a functional block diagram illustrating example vehicle 100, which may be configured to operate fully or partially in an autonomous mode. More specifically, vehicle 100 may operate in an autonomous mode without human interaction through receiving control instructions from a computing system. As part of operating in the autonomous mode, vehicle 100 may use sensors to detect and possibly identify objects of the surrounding environment to enable safe navigation. In some implementations, vehicle 100 may also include subsystems that enable a driver to control operations of vehicle 100.

As shown in FIG. 1, vehicle 100 may include various subsystems, such as propulsion system 102, sensor system 104, control system 106, one or more peripherals 108, power supply 110, computer system 112, data storage 114, and user interface 116. In other examples, vehicle 100 may include more or less subsystems, which can each include multiple elements. The subsystems and components of vehicle 100 may be interconnected in various ways. In addition, functions of vehicle 100 described herein can be divided into additional functional or physical components, or combined into fewer functional or physical components within implementations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some implementations, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some implementations, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example implementations. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar 126, laser rangefinder/LIDAR 128, camera 130, steering sensor 123, and throttle/brake sensor 125, among other possible sensors. In some implementations, sensor system 104 may also include sensors configured to monitor internal systems of the vehicle 100 (e.g., O₂ monitor, fuel gauge, engine oil temperature, brake wear).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar 126 may represent one or more systems configured to use radio signals to sense objects, including the speed and heading of the objects, within the local environment of vehicle 100. As such, radar 126 may include antennas configured to transmit and receive radio signals. In some implementations, radar 126 may correspond to a mountable radar system configured to obtain measurements of the surrounding environment of vehicle 100.

Laser rangefinder/LIDAR 128 may include one or more laser sources, a laser scanner, and one or more detectors, among other system components, and may operate in a coherent mode (e.g., using heterodyne detection) or in an incoherent detection mode. Camera 130 may include one or more devices (e.g., still camera or video camera) configured to capture images of the environment of vehicle 100.

Steering sensor 123 may sense a steering angle of vehicle 100, which may involve measuring an angle of the steering wheel or measuring an electrical signal representative of the angle of the steering wheel. In some implementations, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve or carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in navigating vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some implementations, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some implementations, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software operable to process and analyze images in an effort to determine objects, environmental objects (e.g., stop lights, road way boundaries, etc.), and obstacles. As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as CDMA, EVDO, GSM/GPRS, or 4G cellular communication, such as WiMAX or LTE. Alternatively, wireless communication system 146 may communicate with a wireless local area network (WLAN) using WiFi or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some implementations. For instance, power supply 110 may include one or more batteries configured to provide electrical power. Vehicle 100 may also use other types of power supplies. In an example implementation, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory computer readable medium, such as data storage 114. In some implementations, computer system 112 may represent a plurality of computing devices that may serve to control individual components or subsystems of vehicle 100 in a distributed fashion.

In some implementations, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, and control system 106), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of an environment of vehicle 100 operating in an autonomous mode. The state of the environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar unit 126 may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100, i.e., wireless communication system 146, computer system 112, data storage 114, and user interface 116, as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

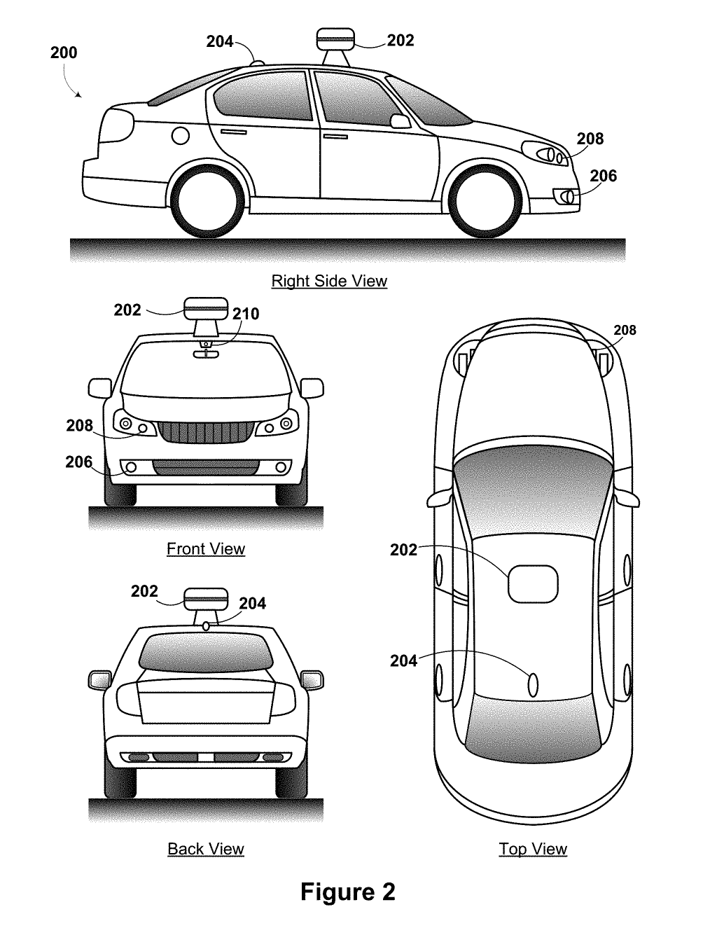

FIG. 2 depicts an example physical configuration of vehicle 200, which may represent one possible physical configuration of vehicle 100 described in reference to FIG. 1. Depending on the embodiment, vehicle 200 may include sensor unit 202, wireless communication system 204, radio unit 206, deflectors 208, and camera 210, among other possible components. For instance, vehicle 200 may include some or all of the elements of components described in FIG. 1. Although vehicle 200 is depicted in FIG. 2 as a car, vehicle 200 can have other configurations within examples, such as a truck, a van, a semi-trailer truck, a motorcycle, a golf cart, an off-road vehicle, or a farm vehicle, among other possible examples.

Sensor unit 202 may include one or more sensors configured to capture information of the surrounding environment of vehicle 200. For example, sensor unit 202 may include any combination of cameras, radars, LIDARs, range finders, radio devices (e.g., Bluetooth and/or 802.11), and acoustic sensors, among other possible types of sensors. In some implementations, sensor unit 202 may include one or more movable mounts operable to adjust the orientation of sensors in sensor unit 202. For example, the movable mount may include a rotating platform that can scan sensors so as to obtain information from each direction around the vehicle 200. The movable mount of sensor unit 202 may also be moveable in a scanning fashion within a particular range of angles and/or azimuths.

In some implementations, sensor unit 202 may include mechanical structures that enable sensor unit 202 to be mounted atop the roof of a car. Additionally, other mounting locations are possible within examples.

Wireless communication system 204 may have a location relative to vehicle 200 as depicted in FIG. 2, but can also have different locations within implementations. Wireless communication system 200 may include one or more wireless transmitters and one or more receivers that may communicate with other external or internal devices. For example, wireless communication system 204 may include one or more transceivers for communicating with a user's device, other vehicles, and roadway elements (e.g., signs, traffic signals), among other possible entities. As such, vehicle 200 may include one or more vehicular communication systems for facilitating communications, such as dedicated short-range communications (DSRC), radio frequency identification (RFID), and other proposed communication standards directed towards intelligent transport systems.

Camera 210 may have various positions relative to vehicle 200, such as a location on a front windshield of vehicle 200. As such, camera 210 may capture images of the environment of vehicle 200. As illustrated in FIG. 2, camera 210 may capture images from a forward-looking view with respect to vehicle 200, but other mounting locations (including movable mounts) and viewing angles of camera 210 are possible within implementations. In some examples, camera 210 may correspond to one or more visible light cameras. Alternatively or additionally, camera 210 may include infrared sensing capabilities. Camera 210 may also include optics that may provide an adjustable field of view.

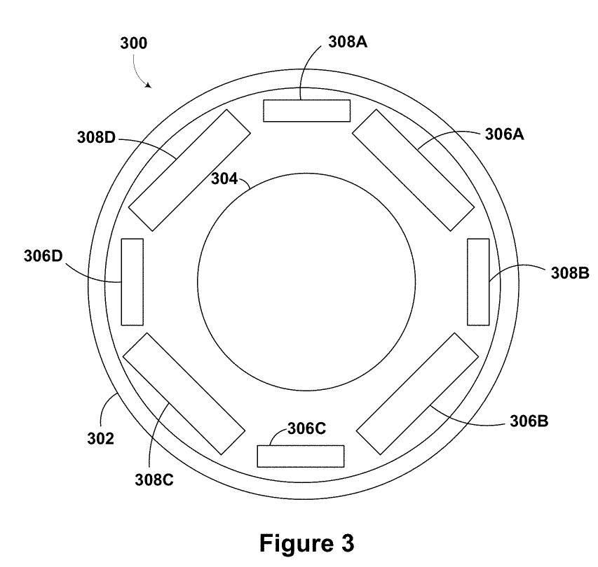

FIG. 3 illustrates a top view of example mountable radar system 300. Radar system 300 includes housing structure 302, interior components 304, a first set of radar units (radar unit 306A, radar unit 306B, radar unit 306C, and radar unit 306D), and a second set of radar units (radar unit 308A, radar unit 308B, radar unit 308C, and radar unit 308D). Although radar system 300 is shown having various components, radar system 300 may include more or less components within other implementations. For instance, radar system 300 may further include other subsystems that an autonomous or semi-autonomous vehicle may utilize to measure a vehicle's environment, such as a GPS system or one or more cameras. In addition, the configuration of radar system 300 can vary within other examples, such as more or less radar units, a larger or smaller housing structure, or different overall layout (e.g., rectangular configuration, among other possibilities.

Radar system 300 may correspond to a mountable radar system that may couple to a portion of a vehicle. For instance, a computing system of a vehicle may receive radar data from radar system 300 to determine navigation operations for the vehicle. As shown in FIG. 3, radar system 300 includes housing structure 302, which serves as a base for connecting and protecting the various radar units and other components within radar system 300. Housing structure 302 may also include one or more structural components operable to couple radar system 300 to a vehicle or another entity. For example, housing structure 302 may include one or more mechanical components configured to connect radar system 300 to a roof of a vehicle such that one or more radar units (e.g., sensor 308A-308D) have a radar beam directed at an angle pointed toward a ground surface. In some instances, housing structure 302 may connect at different positions on the roof of a vehicle. Housing structure 302 may also connect to a vehicle in other possible ways within examples. For instance, housing structure 302 may include a plug that connects into a socket positioned on a top of a vehicle.

In a further implementation, housing structure 302 may be configured to couple to a roof of a vehicle such that a first radar unit (e.g., radar unit 308A) of the second set of radar units has a respective broadside beam direction approximately at a forward direction of the vehicle. With this configuration, radar unit 308B and radar unit 308D may have broadside beam directions approximately towards the sides of the vehicle and radar unit 308C may have a broadside beam direction approximately at a backward direction of the vehicle. In addition, also with this configuration, radar unit 306A and radar unit 306B may have respective broadside beam directions approximately +45 degrees and −45 degrees, respectively, from a forward direction of the vehicle when housing structure 302 is coupled to the vehicle. Similarly, radar unit 306C and radar unit 306D may have broadside beam directions +45 degrees and −45 degrees, respectively, from a backward direction of the vehicle when housing structure 302 is coupled to the vehicle. Housing structure 302 may connect to a vehicle such that radar units of radar system 300 have other orientations relative to the vehicle within examples.

Housing structure 302 may include various materials configured to permit operation of the radar units while also providing protection to components of radar system 300. For instance, housing structure 302 may include plastic, glass, metal, or other possible materials. Housing structure 302 can also have different configurations within implementations, such as a rectangular configuration.

As shown in FIG. 3, housing structure 302 includes interior components 304 that can correspond to various types of components that radar system 300 may use. For instance, interior components 304 may include one or more power sources configured to provide power to sensors and other components (e.g., cameras) of radar system. In a further implementation, radar system 300 may include a power source that transfers power from the vehicle to all the radar units and other components. Interior components 304 may also include one or more components configured to manipulate operation of one or more radar units positioned in radar system 300. For instance, interior components 304 may include a cooling system configured to prevent radar units and other components of radar system 300 from overheating.

Interior components 304 may further include other sensors or subsystems that may assist autonomous operation of a vehicle. For example, interior components 304 may include a GPS system or one or more cameras configured to capture images of the vehicle's environment. For example, housing structure 302 may include a camera array, a series of LIDAR sensors, and additional range radar units, among other possible sensors. In some instances, radar system 300 may include short range radar units to detect occupants (e.g., potential passengers) entering or exiting the vehicle.

In some implementations, interior components 304 may have a position within radar system 300 above or below the first set and second set of radar units. As an example implementation, radar system 300 may include a level of radar units and another level for one or more cameras positioned above the level containing the radar units. Additionally, radar system 300 may include one or more interfaces to connect to systems of a vehicle, control cooling and heating of components, facilitate communication between radar system 300 and other entities (e.g., other computing systems), and controlling sensors and resources, among other possible components. Radar system 300 may include one or more computing systems configured to control operations of radar system 300. In some instances, the computing system may process incoming radar signals prior to providing radar data to other systems. Interior components 304 may include more or less components within other example configurations of radar system 300.

Radar system 300 is shown having a first set of radar units (radar unit 306A, radar unit 306B, radar unit 306C, and radar unit 306D), and a second set of radar units (radar unit 308A, radar unit 308B, radar unit 308C, and radar unit 308D. However, radar system 300 may include more or less sets of radar units with each set having a various number of radar units within other example implementations. For example, radar system 300 may include three sets of radar units in another implementation. Similarly, the amount of other sensors within radar system 300 can vary within examples. For instance, an example radar system may include more or fewer LIDAR units and/or cameras, etc.

In some implementations, radar units 306A-306D in the first set of radar units may operate in a first mode and radar units 308A-308D in the second set of radar units may operate in a second mode. For example, the first set of radar units may operate in a long range mode, which may involve capturing measurements up to a given distance from radar system 300. A computing system controlling aspects of an autonomous vehicle may use measurements from the first set of radar units to detect objects positioned farther away from the vehicle. By contrast, in some implementations, the second set of radar units may operate in a short range mode to provide measurements of an area located closer to radar system 300. For instance, a computing system may use measurements from the second set of radar units to detect when objects enter into an area located proximate to the vehicle. Radar units within the first set and second set may be configured to operate in other modes (e.g., longer or shorter) within implementations. Additionally, radar system 300 may also include other types of radar units within examples. For instance, in an example implementation, radar system 300 may include multiple radar units arranged in a circular configuration to obtain measurements at a medium range.

As indicated above, in some implementations, radar units 306A-306D may operate in a long range mode. One or more radar units of the first set of radar units may include one or more of a synthetic aperture radar (SAR) array, a multiple-input multiple-output (MIMO) transmission array, and a receiver array. In particular, as an example illustration, radar unit 306A may include a SAR array with a beam width of approximately 45 degrees and a MIMO transmission array with a beam width of approximately 90 degrees. In a further implementation, the SAR array of a radar unit may have a beam that is electronically steerable. For instance, the SAR array may scan its beam approximately over 22.5, 45, or 90 degrees. In another implementation, radar units 306A-306D may include 4 SAR arrays and 4 MIMO arrays in addition to a 15 channel Uniform Linear Array (ULA) array.

When one or more radar units of radar units 306A-306D include both the SAR array and MIMO array, those radar units may operate in a MIMO and a SAR mode. For instance, when operating in a SAR mode, radar units 306A-306D of radar system 300 may transmit and receive multiple radar pulses, which may occur while a vehicle is in motion or stationary. When the vehicle is in motion, radar system 300 may transmit and receive radar signals that reflect from objects positioned at various locations of the surrounding environment. Each received signal may contain information about a variety of radar targets within a field of view of radar system 300. Because the signals were transmitted and received from different locations, each received signal may contain different information about the variety of radar targets due to the signals being reflected from the target objects at different angles relative to the radar unit of the vehicle. By receiving the signals from different angles, radar system 300 may have a higher resolution than traditional scanning radar systems.

In some examples, radar system 300 may be configured to transmit radar signals in a direction normal to the direction of travel of the vehicle via the SAR radar functionality. As such, radar system 300 may enable a computing system to determine information about roadside objects along which the vehicle passes, such as curbs, other vehicles, signs. The computing system may use measurements from radar system 300 to determine two dimensional information (e.g., the distances of various objects relative from the roadside) and three dimensional information (e.g. a point cloud of various portions of detected objects). As a result, the computing system may use measurements from radar system 300 to “map” the sides of the road during navigation of the vehicle.

Radar system 300 may also operate in a MIMO mode by transmitting and receiving multiple radar pulses from different antenna apertures (e.g. antenna arrays). The term MIMO comes from a radar system having multiple inputs and multiple outputs. It may be desirable for each of the multiple input antennas and each of the multiple output antennas to operate uncoupled (that is receive a separate diverse signal) from each other respective input and output antenna.

A radar unit may have MIMO capabilities in multiple ways. First, spatial diversity (i.e. a difference between physical locations) of radar transmitters (and/or receivers) may enable MIMO functionality. Second, coding diversity may enable a radar system to transmit a signal that has a respective coding. The coding may include multiple signals that are orthogonal to each other so virtual diverse channels can be created. In some systems, a combination of spatial diversity and coding diversity may be used to establish the MIMO diversity. Yet, additionally, time division multiple access (TDMA) can provide time diversity to allow multiple transmission and reception antennas to be used. Also, in other examples, a frequency division multiple access (FDMA) may also be used for diversity.

Radar units 306A-306D may have various positions within radar system 300. For example, FIG. 3 shows radar units 306A-306D positioned at approximately 90 degree increments extending around housing structure 302. More specifically, radar units 306A-306D may be positioned around housing structure 302 at 45 degrees, 135 degrees, 225 degrees, and 315 degrees, respectively.

In some implementations, radar units 308A-308D may operate in a short range mode, and may differ in configuration from radar units 306A-306D. For instance, one or more radar units 308A-308D may include one or more of a transmit array and a receiver array. The transmit array may have various configurations within implementations, such as a linear array configuration. The receiver array may connect to a digital beam forming unit.

Radar units 308A-308D may have various positions within radar system 300. For example, FIG. 3 shows radar units 308A-308D positioned at approximately 90 degree increments extending around housing structure 302. More specifically, as an example illustration, radar units 308A-308D may be positioned around housing structure 302 at 0 degrees, 90 degrees, 180 degrees, and 270 degrees, respectively. With this configuration, for example, a computing system of a vehicle may use measurements from radar units 308A-308D for near range object detection and analysis.

In some implementations, radar units 306A-306D may have a different configuration and/or use more or less power the radar units 306A-306D. For instance, radar units 306A-306D may have a greater transmission power to transmit signals at long ranges than radar units 308A-308D transmitting signals at short ranges.

In a further implementation, radar system 300 may operate in accordance with other sensors positioned on a vehicle. For instance, radar system 300 may provide a control system of the vehicle with measurements that supplement measurements from other radar units and sensors positioned on the vehicle. Radar system 300 may serve as a primary radar system for an autonomous vehicle with other sensors providing additional information to a computing system to determine navigation instructions for the vehicle.

In another implementation, radar system 300 may further be configured to rotate or otherwise adjust orientation relative to a vehicle when coupled to the vehicle. For instance, housing structure 302 may rotate relative to the vehicle such that the radar units may change beam direction relative to the vehicle. For example, entire radar system 300 may rotate back and forth to scan in azimuth to detect other vehicles and/or traffic signals, among other entities. Radar units of radar system 300 may also be operable to adjust beam heights. For instance, a computing system may manipulate the beam heights of one or more radar units operating in radar system 300.

In a further implementation, radar system 300 may further include additional sensors, such as a LIDAR unit and/or a camera array. For example, radar system 300 may include a variety of additional sensors positioned in housing structure 302 (e.g., a pod of sensors and radar). As a result, radar system 300 may utilize sensor data from other types of sensors to supplement execution of radar measurements of the environment. In some instances, radar system 300 may use information from other sensors positioned at other locations on the vehicle and/or remotely. For instance, radar system 300 may utilize maps, LIDAR data, and/or images from a camera array, among other possible sources of information. As such, radar system 300 may operate in a network of sensors configured to provide information to a computing system controlling aspects of navigation of the vehicle. The computing system may use various processes to process incoming information from the various sensors (e.g., radar system 300, LIDAR). For example, the computing system may perform data fusion processes to utilize information from various sensors to determine navigation operations.

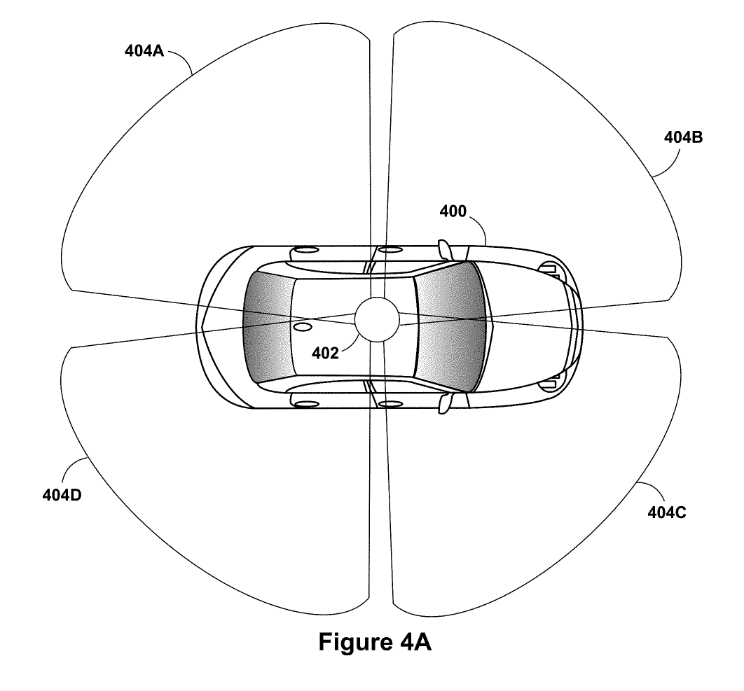

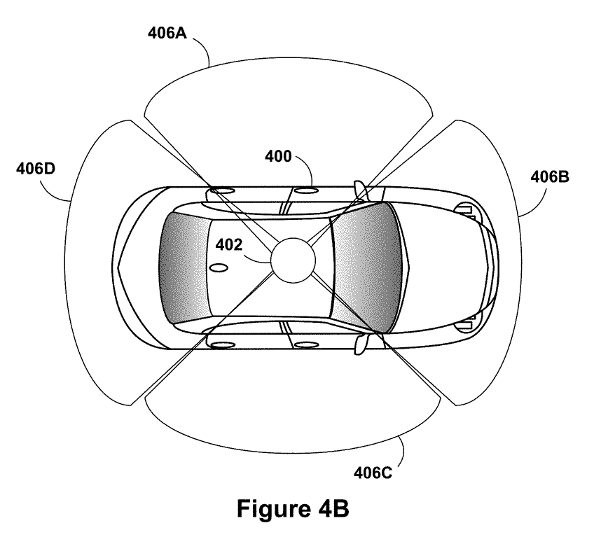

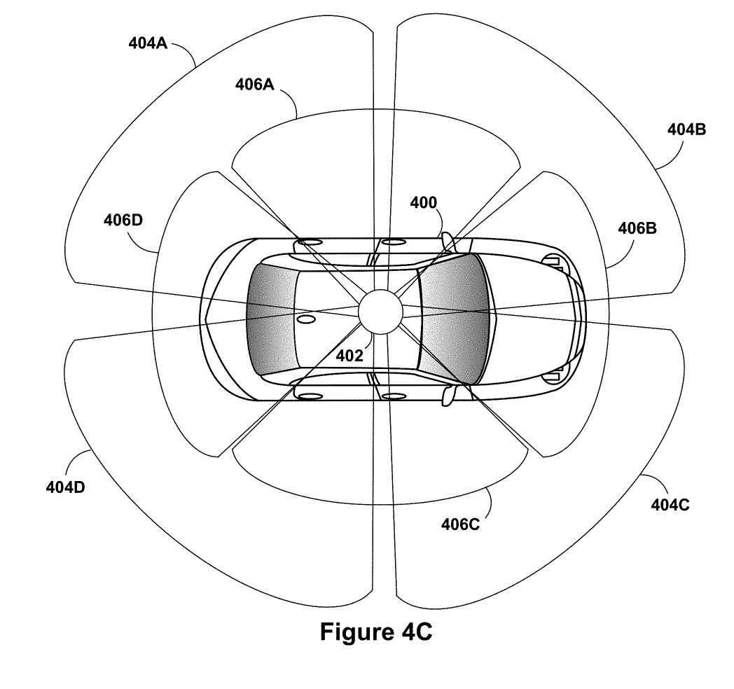

FIG. 4A depicts a top view illustration of radar system 402 transmitting long range radar signals from vehicle 400. In particular, radar system 402 is positioned on the roof of vehicle 400 and transmitting long range radar signals covering four quadrants (long range quadrant 404A, long range quadrant 404B, long range quadrant 404C, long range quadrant 404D) around vehicle 400. Long range quadrants 404A-404D are shown in FIG. 4A for illustration purposes and may differ in size and orientation within implementations. For example, the four quadrants may overlap and/or extend farther from the vehicle in some implementations. Although long range quadrants 404A-404D are shown as uniform coverage areas in 90 degree increments, other implementations may include long range quadrants covering other size areas, such as 120 degree increments coverages. Similarly, long range quadrants 404A-404D may include a combination of different size coverage areas, such as a 90 degree coverage area in addition to a couple 120 degree coverage areas. Radar system 402 may include components that enable adjustment of sizes and areas covered by radar units.

In some implementations, radar system 402 may include four radar units arranged in a radar system to transmit long range radar signals as shown in FIG. 4A. In particular, each radar unit may operate in a long range mode and obtain measurements of objects positioned at distances within the illustrated quadrants. For instance, the long range radar units may be positioned in a circular configuration in radar system 402 such that the long range radar units are positioned in 90 degree increments.

In a further implementation, radar system 402 may include a greater or fewer number of radar units transmitting long range radar signals. As a result, radar system 402 may measure aspects of the surrounding environment of vehicle 400 in a greater or fewer number of angular ranges than the four quadrants shown in FIG. 4A, depending on the number and other parameters of the radar units.

FIG. 4B depicts a top view illustration of radar system 402 transmitting short range radar signals from vehicle 400. More specifically, radar system 402 is positioned on the roof of vehicle 400 and shown transmitting short range radar signals covering four quadrants (short range quadrant 406A, short range quadrant 406B, short range quadrant 406C, short range quadrant 406D) around vehicle 400. For example, radar system 402 may transmit four short range radar quadrants using four short range radar units arranged at ninety-degree increments in radar system 402. Short range quadrants 406A-406D are shown in FIG. 4B for illustration purposes and may differ in size and orientation within implementations. For example, the four quadrants may overlap and/or extend farther or closer from the vehicle in some implementations.

In some implementations, radar system 402 may connect to the roof of vehicle 400 such that the radar units transmit the short range radar signals at a downward orientation towards the road that vehicle 400 is traveling along. Similarly, radar system 402 may connect to the roof of vehicle 400 such that one or more radar units are configured at other orientations relative to the ground (e.g., an upward orientation for the long range radar units).

FIG. 4C depicts a top view illustration of radar system 402 transmitting long range and short range radar signals from vehicle 400. As shown, the example illustration depicts both the long range quadrants 404A-404D depicted in FIG. 4A and the short range quadrants 406A-406D depicted in FIG. 4B. Long range quadrants 404A-404D and short range quadrants 406A-406D are shown covering an area located nearby vehicle 400 as well as areas extending farther away from vehicle 400.

Long range quadrants 404A-404D are depicted in FIG. 4C extending at angles from the forward and backward orientation of vehicle 400, but may have other orientations within examples. For example, radar system 402 may have an orientation relative to vehicle 400 such that long range quadrant 404A extends in front of vehicle 400 rather than at an angle relative to the front of vehicle 400. As such, the orientation and position of short range quadrants 406A-406D may also differ within implementations.

In some instances, measurements from radar system 402 may supplement information obtained by other sensors assisting autonomous operation of vehicle 400. For instance, a computing system may use radar data from radar system 402 in combination with images from a camera array, information from one more maps, and/or LIDAR point cloud data, among other possible information. Radar system 402 may use information from others sensors while performing radar analysis of the environment. For instance, radar system 402 may use maps depicting the environment to assist in measuring the environment. In some implementations, radar system 402 may include other types of sensors within the same housing as the various radar units. A computing system may fuse sensor data from the variety of sensors together for further analysis and use.

In a further implementation, radar system 402 may be configured to rotate during operation. For instance, the entire physical unit of radar system 402 may rotate to adjust orientation relative to vehicle 400. Similarly, radar system 402 may physically adjust orientation relative to vehicle 400 to scan different regions of the surrounding environment. In some implementations, radar system 402 may also adjust vertical orientation relative to vehicle 400. For instance, radar system 402 may be configured to adjust orientation such that radar units may project radar signals towards the ground or upward, such as to capture measurements of a bridge or sign positioned above vehicle 400.

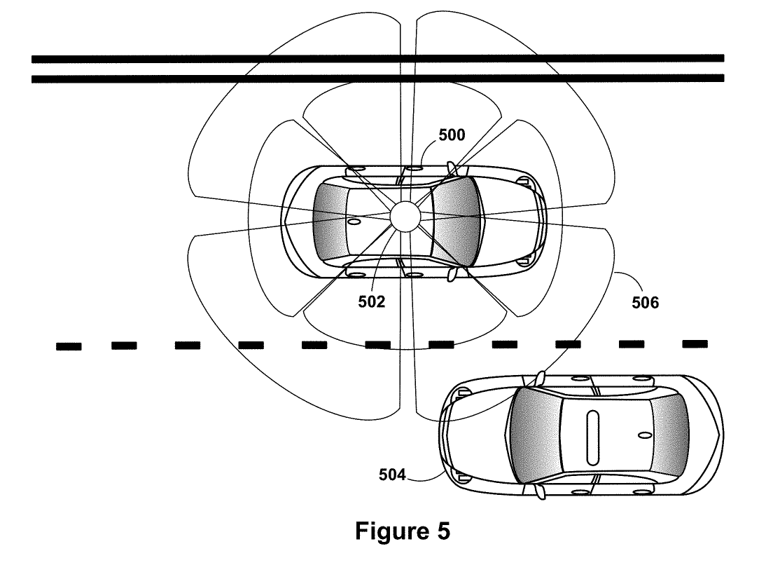

FIG. 5 illustrates an example scenario of vehicle 500 using radar system 502. In particular, a computing system of vehicle 500 may detect the presence of vehicle 504 using radar signals (e.g., long range quadrant 506) from radar system 502. As vehicle 500 navigates the environment, radar system 502 may capture measurements of the surrounding areas nearby vehicle 500. For instance, radar system 502 may enable a computing system to determine a position of road elements (e.g., curb, medians) relative to a position of vehicle 500. Radar system 502 may also enable the computing system to detect other vehicles (e.g., vehicle 504), signs, cyclists, pedestrians, and traffic signals, among other possible objects. In particular, as shown in FIG. 5, a computing system may receive measurements from radar system 502 that indicates the presence of vehicle 504 located in long range quadrant 506 relative to vehicle 500.

In further implementations, radar system 502 may detect multiple vehicles or other types of objects at the same time. As such, a computing system of vehicle 500 may determine control operations for vehicle 500 based on measurements from radar system 502 and possibly other sensors that indicate the presence of nearby objects. In some instance, the computing system may develop future navigation operations for vehicle 500 based on detecting objects in the distance using long range radar from radar system 502. The computing system may also simultaneously manage navigation through detecting objects (e.g., the road curb) and other elements using short range radar from radar system 502.

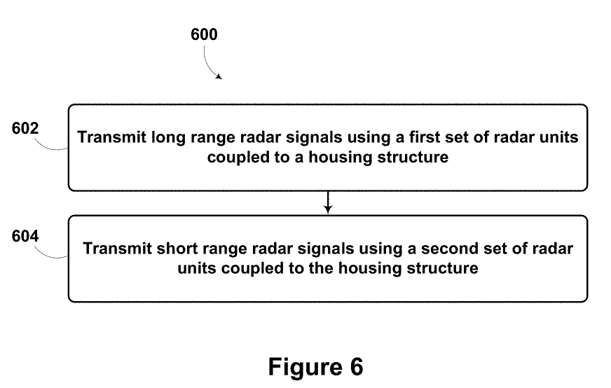

FIG. 6 is a flowchart of example method 600 for implementing a mountable radar system. Method 600 represents an example method that may include one or more operations, functions, or actions, as depicted by one or more of blocks 602 and 604, each of which may be carried out by any of the systems shown in FIGS. 1-3, 4A-4C, and 5, among other possible systems. Those skilled in the art will understand that the flowchart described herein illustrate functionality and operation of certain implementations of the present disclosure. In this regard, each block of the flowchart may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art. In examples, a computing system may cause a radar system to perform one or more blocks of method 600.

At block 602, method 600 includes transmitting long range radar signals using a first set of radar units coupled to a housing structure. As shown in FIG. 4A, a radar system (e.g., radar system 402) may measure the surrounding environment of a vehicle using long range signals. The radar system may detect objects positioned at locations up to distances permitted by the long range signals. For instance, a computing system of a vehicle may use long range measurements to detect potential obstacles that may have a position in the future path of the vehicle.

At block 604, method 600 includes transmitting short range radar signals using a second set of radar units coupled to the housing structure. As shown in FIG. 4B, the radar system may measure the surrounding environment of a vehicle using short range signals. In particular, the radar system may detect objects, such as the roadway, signs, and nearby vehicles as the vehicle navigates. As such, a computing system controlling the vehicle may process measurements from the short range radar units to determine navigation operations for the vehicle.

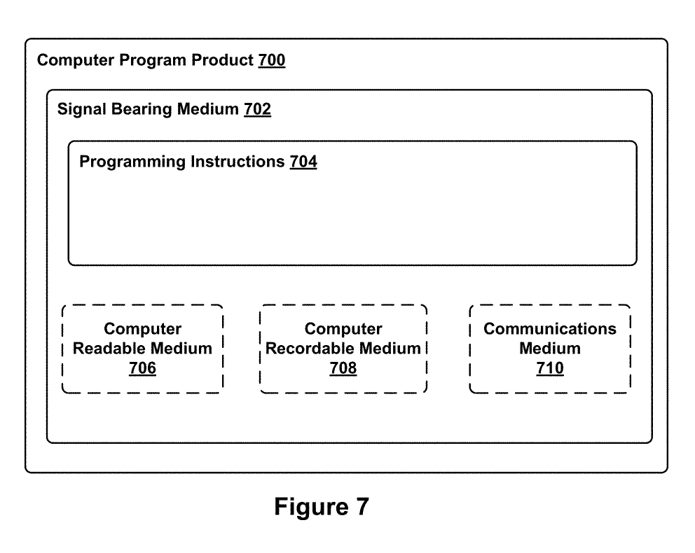

FIG. 7 is a schematic illustrating a conceptual partial view of an example computer program product that includes a computer program for executing a computer process on a computing device, arranged according to at least some embodiments presented herein. In some embodiments, the disclosed methods may be implemented as computer program instructions encoded on a non-transitory computer-readable storage media in a machine-readable format, or on other non-transitory media or articles of manufacture.

In one embodiment, example computer program product 700 is provided using signal bearing medium 702, which may include one or more programming instructions 704 that, when executed by one or more processors may provide functionality or portions of the functionality described above with respect to FIGS. 1-6. In some examples, the signal bearing medium 702 may encompass a non-transitory computer-readable medium 706, such as, but not limited to, a hard disk drive, a Compact Disc (CD), a Digital Video Disk (DVD), a digital tape, memory, etc. In some implementations, the signal bearing medium 702 may encompass a computer recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Similarly, the signal bearing medium 702 may correspond to a remote storage (e.g., a cloud). A computing system may share information with the cloud, including sending or receiving information. For example, the computing system may receive additional information from the cloud to augment information obtained from sensors or another entity. Thus, for example, the signal bearing medium 702 may be conveyed by a wireless form of the communications medium 710.

The one or more programming instructions 704 may be, for example, computer executable and/or logic implemented instructions. In some examples, a computing device such as the computer system 112 of FIG. 1 may be configured to provide various operations, functions, or actions in response to the programming instructions 704 conveyed to the computer system 112 by one or more of the computer readable medium 706, the computer recordable medium 708, and/or the communications medium 710.

The non-transitory computer readable medium could also be distributed among multiple data storage elements and cloud (e.g., remotely), which could be remotely located from each other. The computing device that executes some or all of the stored instructions could be a vehicle, such as the vehicle 200 illustrated in FIG. 2. Alternatively, the computing device that executes some or all of the stored instructions could be another computing device, such as a server.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

What is claimed is:

1. A radar system comprising:
a housing structure;
a first set of radar units coupled to the housing structure, wherein the first set of radar units comprises four radar units with each respective radar unit mounted at approximately 90 degree increments and wherein the first set of radar units operate in a long range mode; and
a second set of radar units coupled to the housing structure, wherein the second set of radar unit comprises four radar units with each respective radar unit mounted at approximately 90 degrees increments, wherein each radar unit of the second set of radar units is positioned between two radar units of the first set of radar units and wherein the second set of radar units operate in a short range mode.

2. The radar system of claim 1, wherein the housing structure is configured to couple to a roof of a vehicle.

3. The radar system of claim 1, wherein the housing structure is configured to couple to a roof of a vehicle such that one or more radar units of the second set of radar units have a radar beam directed at an angle pointed toward a ground surface.

4. The radar system of claim 1, wherein a radar transmission power of the first set of radar units is greater than a radar transmission power of the second set of radar units.

5. The radar system of claim 1, wherein one or more radar units of the first set of radar units comprise:
a synthetic aperture radar (SAR) array;
a multiple-input multiple-output (MIMO) transmission array; and
a receiver array.

6. The radar system of claim 5, wherein the SAR array has a beam width of approximately 45 degrees, and the MIMO transmission array has a beam width of approximately 90 degrees.

7. The radar system of claim 1, wherein one or more radar units of the second set of radar units comprise:
a transmit array; and
a receiver array.

8. The radar system of claim 7, wherein the transmit array is a linear array, and wherein the receiver array is coupled to a digital beam forming unit.

9. The radar system of claim 1, wherein the housing structure is configured to couple to a roof of a vehicle such that a first radar unit of the second set of radar units has a respective broadside beam direction approximately at a forward direction of the vehicle.

10. The radar system of claim 1, wherein the housing structure is configured to couple to a roof of a vehicle such that a first radar unit and a second radar unit of the first set of radar units have respective broadside beam directions approximately 45 degrees from a forward direction of the vehicle when the housing structure is coupled to the vehicle.

11. The radar system of claim 1, wherein respective radar units of the first set of radar units are coupled to the housing structure at 45 degrees, 135 degrees, 225 degrees, and 315 degrees, and
wherein respective radar units of the second set of radar units are coupled to the housing structure at 0 degrees, 90 degrees, 180 degrees, and 270 degrees.

12. A vehicle-mounted radar system comprising:
a housing structure coupled to a roof of a vehicle;
a first set of radar units coupled to the housing structure, wherein the first set of radar units comprises four radar units with each respective radar unit mounted at approximately 90 degree increments and wherein the first set of radar units operate in a long range mode; and
a second set of radar units coupled to the housing structure, wherein the second set of radar unit comprises four radar units with each respective radar unit mounted at approximately 90 degrees increments, wherein each radar unit of the second set of radar units is positioned between two radar units of the first set of radar units and wherein the second set of radar units operate in a short range mode.

13. The vehicle-mounted radar system of claim 12, wherein one or more radar units of the second set of radar units have a radar beam angle at a downward orientation.

14. The vehicle-mounted radar system of claim 12, wherein one or more radar units of the first set of radar units comprise:
a synthetic aperture radar (SAR) array;
a multiple-input multiple-output (MIMO) transmission array; and
a receiver array.

15. The vehicle-mounted radar system of claim 14, wherein the SAR array has a beam width of approximately 45 degrees, and the MIMO transmission array has a beam width of approximately 90 degrees.

16. The vehicle-mounted radar system of claim 12, wherein one or more radar units of the second set of radar units comprise:
a transmit array; and
a receiver array.

17. The vehicle-mounted radar system of claim 16, wherein the transmit array is a single operation array, and wherein the receiver array is a digital beam receiver.

18. The vehicle-mounted radar system of claim 12, further comprising:
a power source, wherein the first set of radar units and the second set of radar units are both powered by the power source.

19. A method of operating a radar system:
transmitting long range radar signals using a first set of radar units coupled to a housing structure, wherein the first set of radar units comprises four radar units with each respective radar unit mounted at approximately 90 degree increments; and
transmitting short range radar signals using a second set of radar units coupled to the housing structure, wherein the second set of radar units comprises four radar units with each respective radar unit mounted at approximately 90 degree increments, and wherein each radar unit of the second set of radar units is positioned between two radar units of the first set of radar units.

20. The method of claim 18, wherein transmitting long range signals using the first set of radar units comprises:
transmitting the long range signals using a SAR mode or a MIMO mode.
